(19) United States
(12) Patent Application Publication
(10) Pub. No.: US 2013/0216815 A1
(43) Pub. Date: Aug. 22, 2013

(54) COMPOSITE MATERIALS AND METHODS AND APPARATUS FOR MAKING SAME

(71) Applicant: Douglas Coyle, Aurora (CA)

(72) Inventor: Douglas Coyle, Aurora (CA)

(73) Assignee: TORXX GROUP INC, Richmond Hill, ON (CA)

(21) Appl. No.: 13/818,894

(22) PCT Filed: Aug. 25, 2011
(86) PCT No.: PCT/CA11/00984

§ 371 Date: May 6, 2013

Related U.S. Application Data
(60) Provisional application No. 61/376,786, filed on Aug. 25, 2010.

(51) Int. Cl. B28B 5/00

(52) U.S. Cl. CPC B28B 5/00
USPC 428/221; 264/102; 264/69

(57) ABSTRACT

A composite material comprising a solid particulate material and a matrix material encapsulating the solid particulate material, wherein each dividual particle of the solid particulate material is in contact with at least one adjacent solid particle. A method comprising providing a solid particulate material, providing a mold, evacuating the solid particulate material in the mold to remove gas in the void space between the particles of the particulate material, evaluating the mold, introducing the evacuated solid particulate material into the mold, providing a fluid matrix material, and introducing the fluid matrix material into the void spaces while constraining the solid particulate material.

### FIELD

The present invention relates to composite materials and methods and apparatus for making same.

### BACKGROUND

### Molding and Formation Distortion

At least some materials and methods currently used to mold parts produce part shapes that are dimensionally imprecise because of formation distortion. Formation distortion results from significant material dimensional changes (typically shrinkage and twisting) that occur during the molding, curing and demolding processes. These dimensional changes can be due to a) temperature changes; b) pressure changes; c) material physical phase changes; d) material chemical reactions; and/or e) other material physical state changes.

In order to achieve the desired dimensional precision, in current practice the molded part is often made dimensionally larger than the desired part and excess material is removed to produce a “net shape” part using additional operations, such as machining or grinding, which are generally time consuming and expensive processes.

It would be desirable to have materials and methods of directly molding and/or forming high-precision shapes that would not shrink or distort during molding, curing and demolding, and that would produce high-precision parts without the need for additional operations to achieve desired dimensional tolerances.

### Producing Molds:

Molds (also called forms) are used to shape many materials, including metals, organic polymers (plastics) and ceramics. Mold making is generally a slow and expensive process, especially for precision molds. Molds are generally made of hard or refractory materials in order to be able to withstand the temperatures, pressures and abrasion associated with molding operations.

The making of molds is often accomplished by cutting or abrading away material to form a desired cavity shape. The tool removing material presses against the mold material in order to cut. This pressure causes the work piece material to compress and to move away from the tool. The work of cutting or abrading causes the work piece material to heat up, causing thermal distortion. The cutting or abrading tooling tends to wear with use, with the rate of wear increasing with harder mold materials.

It would be desirable to have materials for making molds that could be cut or abraded with relatively low tool pressure; that would cut or abrade with little heat generation; that have a low coefficient of thermal expansion; and that would be less abrasive or wearing to tooling.

### Sintering and Pressed Shapes:

Parts composed of ceramic materials, refractory metals or other refractory materials are often formed by filling a shape with finely divided particles of the desired material and applying combinations of high-temperature and pressure to consolidate and/or sinter the particles into a desired shape. Processes, such as crushing or grinding, used to produce these finely divided particles, result in particles with sharp contours. The sharp particles bridge easily when flowed into a mold or form, resulting in the formation of many voids and slip planes in the final part that can concentrate applied stress, can reduce the practical strength of parts, and can result in part failure under applied stress.

It would be desirable to have materials and methods that would avoid the above problems and that would produce stronger materials with fewer and smaller material flaws.

Massive presses and tooling, formed from special hardened materials, are generally required to form refractory material parts, in order to withstand the high temperatures and pressures that are applied. The molds and other tooling currently required to form refractory parts are generally expensive to produce and wear rapidly, because of the high temperatures and pressures used and because of the abrasive nature of most refractory materials. This necessitates frequent and expensive tooling replacement, and causes progressively diminished precision as wear progresses between tooling refurbishments.

It would be desirable to have materials and methods of molding and/or forming high-precision shapes from refractory materials, at ambient or moderate temperatures and at ambient or moderate pressures using production equipment that is has significantly lower capital and operating costs.

### Syntactic Foam:

Syntactic foams are composite materials synthesized by filling a metal, polymer or ceramic matrix with hollow particles called microballoons, “syntactic” meaning “put together”. The presence of hollow particles results in lower density, higher strength, a lower coefficient of thermal expansion, and, in some cases, radar or sonar transparency.

Tailorability is one of the biggest advantages of these materials. The matrix material can be selected from almost any metal, polymer or ceramic. A wide variety of microballoons are available, including cenospheres, glass microspheres, and carbon and polymer microballoons. The most widely used and studied foams are glass microballoon-epoxy, glass microballoon-aluminum and cenosphere-aluminum.

The compressive properties of syntactic foams primarily depend on the properties of microballoons, whereas the tensile properties depend on the matrix material that holds the microballoons together. There are two main ways of adjusting the properties of these materials. The first method is to change the volume fraction of microballoons in the syntactic foam structure. The second method is to use microballoons of different wall thickness. In general, the compressive strength of the material is proportional to its density.

These materials were developed in the early 1960s as buoyancy aid materials for marine applications; the other characteristics led these materials to aerospace and ground transportation vehicle applications. Current applications for syntactic foam include buoyancy modules for marine riser tensioners, boat hulls, deep-sea exploration, autonomous underwater vehicles (AUV), parts of helicopters and airplanes, and sporting goods such as soccer balls.

Other applications include: deep-sea buoyancy foams, thermoforming plug assist, radar transparent materials, acoustically attenuating materials, and blast mitigating materials.

A conventional method of producing syntactic foam is to mechanically mix the microballoons into the matrix material. This conventional method has three essential disadvantages: breakage of microballoons during mixing, poor mixing at higher volume fractions of microspheres, and flaw formation.

Breakage: The shear forces involved in mechanical mixing results in the breaking or disintegration of many microballoons, particularly with more viscous matrix materials, which includes most epoxy, metal, organic polymer and ceramic matrix materials. This breakage generally reduces all of the advantageous properties of syntactic foams. The percentage of broken microballoons generally increases with higher volume fractions of microballoons. Processes to remove the broken microspheres are expensive. Mixing is generally carried out at low speeds to minimize breakage, however this increases processing time and costs. It would be desirable to have a method of preparing syntactic foams that did not result in the breakage of a significant number of microballoons.

Poor Mixing: With a viscous matrix material, as the volume fraction of microballoons increases, fewer of the microspheres become fully coated by the matrix material during mixing. This means that the bonding of the matrix phase to the particle phase becomes weaker, reducing the strength and the elastic modulus properties of the syntactic foam. Many desirable properties of syntactic foams, such as lower density and greater compressive strength improve with the volume fraction of microballoons, however poor mixing properties often limits the volume fraction of microballoons to less than the theoretical packing volume maximum. It would be desirable to have a method of producing syntactic foams that results in better coating of microballoons and that allows for the use of a volume fraction of microballoons that approaches the theoretical packing volume maximum.

Flaws: Mechanical mixing of microballoons into a matrix material generally entraps gases within the mix. These entrapped bubbles are flaws at which stress forces can concentrate, significantly reducing the compressive strength and elastic moduli of the syntactic foam. Mechanical mixing also generally produces non-uniform mixtures with regions of lower or higher concentrations of microballoons within the matrix material. These non-uniform regions are flaws at which stresses can concentrate, significantly reducing the compressive strength and elastic moduli of the syntactic foam.

It would be desirable to have a method of producing syntactic foams that results in fewer flaws from entrapped gases and results in fewer flaws from non-uniform concentrations of microballoons within the matrix material.

### Bonding and Precision Assembly:

The bonding together of two or more parts is a common process used in many applications. Most conventional bonding materials have the following problems:

a) Shrinkage and Distortion: Conventional bonding materials tend to shrink and twist as they solidify or harden reducing the strength of bonds and reducing the precision with which component parts can be assembled. It would be desirable to have bonding materials that exhibit negligible shrinkage and negligible distortion during bonding, keeping the relative position and relative orientation of a bonded assembly of parts precise.

b) Imprecise Thickness: With conventional bonding materials, the thickness of the bonding layer is difficult to keep at precisely the optimum thickness over the entire surface area of the mating surfaces as parts are pressed together, which results in weaker bond formation, and loss of precision with respect to relative position and relative orientation of the parts. It would be desirable to have bonding materials that compress to a precise thickness.

### SUMMARY OF THE INVENTION

Certain embodiments of the present invention include a composition comprising a solid particulate material and a matrix material encapsulating the solid particulate material, wherein each individual particle of the solid particulate material is in contact with at least one adjacent solid particulate particle.

Certain embodiments of the present invention include a method for forming a particulate filler reinforced composite comprising providing a mold having a cavity therein and an opening in one surface of said mold and communicating with said cavity; providing a particulate filler material; evacuating the mold cavity; loading a quantity of a particulate filler material in the cavity; and introducing a matrix material into the cavity whereby void spaces in the particulate filler are infused with the matrix material while promoting contact among the particles of the filler.

Certain embodiments of the present invention include a method for forming a particulate filler reinforced composite comprising providing a mold having a cavity therein and an opening in one surface of said mold and communicating with said cavity; providing a particulate filler material; evacuating the mold cavity; loading a quantity of a particulate filler material in the cavity; and introducing a matrix material into the cavity whereby void spaces in the particulate filler are infused with the matrix material while promoting contact among the particles of the filler.

Certain embodiments of the present invention include a apparatus comprising,

a mold comprising a mold void;

a first vessel for holding a solid phase material in fluid communication with the mold void;

a second vessel for holding a matrix material in communication with the mold void;

a first aperture in the mold movable between an open position for permitting the solid phase particles to enter the mold void and a closed position for preventing solid phase particles from entering the mold void and constraining the solid particles within the mold void; and

a second aperture in the mold movable between an open position for permitting the matrix material to enter the mold void and a closed position for preventing matrix material from entering the mold void and constraining the solid particles within the mold.

The apparatus can further comprise

a third vessel for holding a gas phase material in communication with the mold void.

the apparatus can further comprise

a third aperture in the mold movable between an open position for permitting gases and matrix material liquids to exit the mold void while preventing solid phase material from exiting the mold void and a closed position for constraining the solid phase material.

The first aperture is a rotary hole gate.

The second and third apertures are rotary gate apertures.

Certain embodiments of the present invention relate to formulations, compositions and production methods for composite syntactic materials syntactically constructed in such a manner as to form materials with a micrometer-scale and/or nanometer-scale spaceframe internal structures. Such materials are referred to herein as MicroSpaceFrame materials or MSF materials.

Certain embodiments of the invention include syntactic materials with a structure at the micrometer and/or the nanometer scale that is constructed from two or more material phases, with at least one phase, the Particle Phase, consisting of solid particles; and at least one phase, the Matrix Phase, being a fluid phase, capable of infusing and filling the interstitial space between the solid particles of the Particle Phase.

The Particle Phase consists of incompressible solid particles that can be flowed, blown, aspirated or otherwise introduced into the void space of a mold or form in a manner such that the solid particles collectively take up the internal shape of the mold or form, with the individual solid particles in close mechanical contact, such that each individual solid particle has mechanical contact with one or more, (and usually several to a dozen or more), of surrounding nearest neighbor solid particles contained within the internal mold void spaces.

Certain embodiments of the present invention include hollow or solid microspheres, of nanometer or micrometer diameters, usually made of ceramic or glass, used as the structural elements of a rigid spaceframe. The microspheres are poured into a mold and then vibrated to completely fill the mold. A fluid matrix material is then flowed into the mold to fill the spaces between the microspheres, and the fluid matrix is then solidified around the microspheres. The matrix can be a ceramic (used in high-temperature applications) or polymers or metals (used in low to medium temperature applications).

In certain embodiments of the present invention, when a MSF material is prepared in accordance with the teachings of the present invention, the shrinkage of the matrix phase during matrix solidification will result in no appreciable shrinkage or distortion of the bulk shape formed by the solid particle phase contained within the mold.

In certain embodiments of the present invention, when a MSF material is prepared in accordance with the teachings of the present invention, the mechanical strength of the material is increased under stress. Without being bound by theory, it is hypothesized that this is due to the effect of post-tensioning at the micrometer and or nanometer scale. As the matrix phase shrinks around the solid phase particles, the solid particles are held in tension together, provided that the degree of shrinkage does not exceed the elastic deformation limit of the matrix material.

In certain embodiments, MSF materials can be partially fired to produce lightweight, solid “green forms” (for use in the manufacture of net shapes) that are much easier and much less expensive to machine into precision molds or parts than are conventional materials. When these green forms are then fired to full hardness, the micro-scale spaceframe prevents shrinking and distortion, thereby maintaining high precision.

In certain embodiments, MSF green form materials can also be machined at higher cutting speed while maintaining precision accuracy. Machining or grinding of currently used materials, such as metals and ceramics, tends to cause distortion from tool pressure and/or material heating due to tool friction. MSF green forms are rigid yet relatively soft and easy to cut, which reduces the required tool pressure and reduces the heat generated by the forming process. Cutting resistance is reduced even further if the particle phase is constructed of microspheres, which act as multiple, tiny ball bearings, reducing the friction between tool and the part being formed by machining or grinding.

Tool wear is also reduced when using green form MSF materials, because of the reduced friction and reduced tooling pressures applied. Less tool wear results in longer useful tool life, reducing tooling replacement costs. Less tool wear also results in greater precision and accuracy, due to more stable tooling dimensions during forming processes.

### Ceramic Engines:

In certain embodiments, MSF materials according to the present invention can be used in the manufacture of a version of an innovative gerotor (generated rotor) engine design by StarRotor Corporation of Texas, using ceramic materials. The StarRotor engine operates at temperatures that only ceramics can withstand and requires very high precision parts. High temperature materials would be desirable for the rotors, gears, bearings, combustor, ports and other parts of the engine.

However, the precision finishing of conventional ceramics, such as silicon carbide, requires expensive grinding using diamond pastes in a process that does not lend itself to low-cost mass production. MSF materials provide the requisite temperature resistance and ultra-high precision tolerances in a process that can readily be adapted to facilitate inexpensive mass production. Also, regular ceramics currently contain many material flaws that lead to parts failure at stresses far below the theoretical strength of the material in its ideal, defect-free form. MSF materials deliver greater practical strengths because of far fewer and smaller material defects, together with a microstructure that terminates flaw propagation.

Higher power density is very desirable for engines. The power density of a gerotor engine, measured in watts per kilogram and in watts per cubic meter, increases directly with a faster rotational speed. Centrifugal forces on the rotors increases directly with the density of the rotor material and as the square of the rotational speed. The limitation on rotational speed is determined by the strength of the rotor material under rotational stresses. Therefore it would be desirable to have a ceramic gerotor material that is of low density, with high strength under rotational stress, and that is capable of withstanding high temperatures (in excess of 1,200 degrees Celsius).

Certain embodiments of the present invention include MSF materials useful for producing high-precision, high-performance ceramic bearings and gears.

### BRIEF DESCRIPTION OF THE DRAWINGS

The drawings are illustrative and are not drawn to scale.

FIG. 1 is a cross sectional view showing an example of a mold with the mold cavity filled with a MSF material produced in accordance with an embodiment of the invention.

FIG. 2 is a cross sectional view showing the micrometer-scale and/or nanometer-scale structure of a MicroSpaceFrame material, presenting a magnified area of a MSF material, in accordance with an embodiment of the invention.

FIG. 3 is a block diagram showing a method of manufacturing MicroSpaceFrame materials according to an embodiment of the present invention.

FIG. 4 is a cross sectional view showing an example of the ultra-precision bonding of mating surfaces areas of two objects by the use of a MicroSpaceFrame bonding material according to an embodiment of the present invention.

FIG. 5 is an enlarged view of a section of the objects of FIG. 4.

FIG. 6 is a diagram of an apparatus according to an embodiment of the present invention.

FIG. 7a is a top view of a rotary hole gate according to one or more embodiments of the present invention.

FIG. 7b is a side view of a rotary hole gate according to one or more embodiments of the present invention.

FIG. 8 is a diagram of another apparatus according to an embodiment of the present invention.

### DETAILED DESCRIPTION OF THE INVENTION

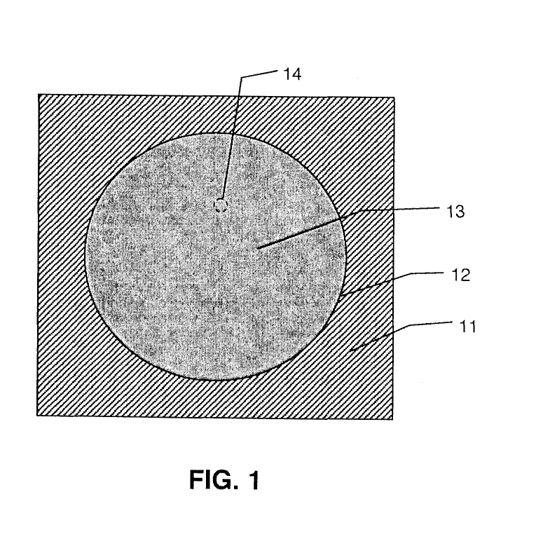

Referring initially to FIG. 1, a cross sectional view is shown of a mold 11 with a mold interior void 12 filled with a MicroSpaceFrame (MSF) material 13 manufactured according to one embodiment of this invention.

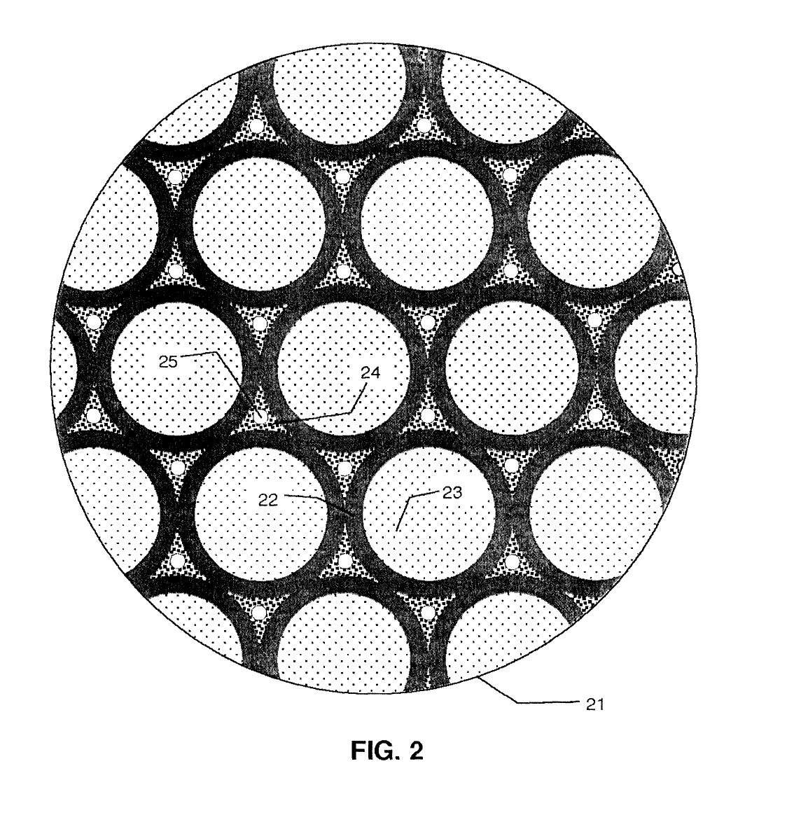

The composite elements forming the MSF material are generally of micrometer or nanometer size, and therefore at a scale visible to the human eye, the MicroSpaceFrame material 13 appears to be a uniform solid. A small circular area 14 of the MSF material 13 is shown magnified in FIG. 2 as circle 21 in order to show the structure of the MSF material.

The Solid Particle Phase:

A solid particle phase of the MSF material 13 is shown in circle 21 of FIG. 2, consisting of many microspheres 16 of equal diameter. The microspheres 22 have hollow void spaces 23, but in general can be hollow or solid.

Each microsphere 22 is shown in mechanical contact with its nearest neighbors. Only two dimensions are shown in FIG. 1, however in three dimensions, each microsphere is, in general, in supporting physical contact with many of its nearest neighbors in all three dimensions. Microspheres at the surface defined by the mold void 12 are also generally in supporting physical contact with the internal surfaces of the mold 11.

During formation of a MSF material, all or almost all, of the solid particles of a MSF material are in supporting physical contact in all three dimensions with the nearest neighbor (i.e. adjacent) solid particles and, for the outermost particles in the spaceframe, with the walls of the mold during formation of the MSF material.

Suitable solid particle material compositions of the particle phase include ceramic, metal, glass, carbon, polymers and other solid materials, with more rigid materials being preferred in order to achieve greater spaceframe rigidity and thereby obtaining greater precision.

The solid particle phase illustrated in this embodiment of the invention consists of spherical shapes, however in general the solid particle phase can consist of particles of any shape, with either smooth or sharp surface contours.

Non-spherical particles tend to “bridge” when flowed into a mold, forming voids and other flaws in the formed material, such as slip planes, where applied stresses can be concentrated, leading to possible material failure under operational stress. Such flaws can also propagate and become larger flaws under stress, particularly under cyclically applied stress, leading to material failure over time.

Spherical particles also flow more rapidly and with less resistance when filling a mold, filling complex mold void contours or shapes with less applied pressure resulting in shorter molding cycle times and fewer problems such as flow blockages.

Therefore, solid particles with smoother contours are preferred over particles with sharper contours, and solid particles as close as practical to perfect spherical particles are most preferred for maximum material strength in embodiments of this invention.

The microspheres shown in this embodiment of the invention, shown in FIG. 1, are all of equal diameter, however in general the microspheres can also be of two or more discrete diameters, or they can consist of one or more varying ranges of diameters.

The microspheres shown in this embodiment of the invention are hollow microspheres, however in general the microspheres can be hollow or solid spheres or a mixture of hollow and solid microspheres.

For microspheres of a given material composition and a given diameter, those with a greater shell thickness have greater crush strength, with solid microspheres having the greatest crush strength. However an offsetting factor is that greater shell thickness results in a denser material. Also, for microspheres of a given material composition and shell thickness, crush strength increases exponentially with decreasing particle diameter. Also for microspheres of a given material composition and a given shell thickness, the density of a microsphere will decrease directly with increasing diameter, since the ratio of surface area to volume ratio of a sphere varies inversely in proportion to the diameter of the sphere.

Therefor for embodiments of this invention where maximum compressive strength is desired, such as for bearings, solid microspheres of smaller average diameter and composed of a stronger material are preferred. Alternatively, for embodiments of this invention where low material density is desired, such as for parts subject to inertial or centripetal stress (e.g. rotors), or where low mass of parts is important (e.g. parts for aerospace applications), hollow microspheres of lower shell thickness and greater average diameter are preferred, consistent with the desired material strength under operational stresses.

It will be obvious to those skilled in the art that, for a given set of operational criteria, methods such as finite element analysis can determine an optimal tradeoff of material strength versus density, and the optimal composition of microsphere diameters and shell thicknesses.

### The Matrix Phase:

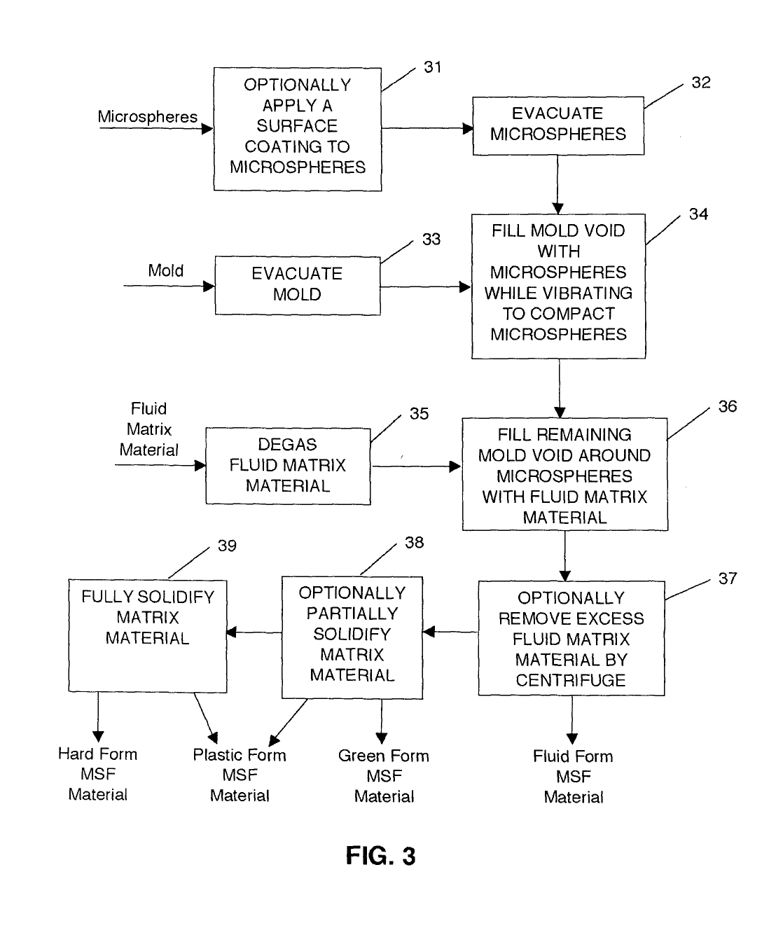

A matrix phase of the MSF material 13 is shown in circle 21 of FIG. 2 consisting of a solid material 24, formed from a liquid precursor material that was previously flowed into the mold void 11 so as to fill the interstitial spaces defined by the space within the mold void 11 and external to the microspheres 22, and then solidified to form the solid matrix phase 24, consistent with an embodiment of this invention described in FIG. 3.

The solidified matrix material 24 surrounds the microspheres 22 and structurally reinforces the points of contact between the microspheres 22 of the particle phase of the MSF material 13. The void spaces 25 within the matrix phase 24 represent voids that form when the liquid precursor shrinks as it is solidified. Examples of processes that would result in the fluid matrix materials shrinking include: (a) the cooling of a molten metal; (b) the curing of an epoxy resin; (c) thermal decomposition of a precursor material; and (d) a chemical reaction between precursor materials.

The precursor material for the matrix phase can be any liquid or plastic material capable of being introduced into the mold so that the liquid or plastic material infiltrates and surrounds the microspheres 22 of the particle phase, and that can be subsequently solidified to form a solid matrix around the particle phase. Suitable liquid or plastic materials include, but are not limited to, a ceramic material formed from a liquid precursor material; or polymers, such as resins, epoxies or thermoplastics; or metals, such as molten aluminum, molten magnesium, or molten metal alloys.

### Method of Manufacture:

FIG. 3: In one or more embodiments, the present invention encompasses a unique method for making MSF materials. Referring to FIG. 3, in one preferred Method:

Step 31: Microspheres are provided and are optionally coated with a surface coating to enhance bonding to the matrix phase or to impart other desirable qualities, such as absorptive properties for microwaves in stealth materials. While microspheres form the solid particle phase in this embodiment, other suitable particle material can be used for the solid particle phase as described in this specification.

Step 32: The microspheres are evacuated of gases (step 32), with the evacuation being sufficient to allow for the infiltration of a fluid matrix material in subsequent processing step 36, with a minimum of entrapment of gas bubbles, in order to avoid the formation of flawed regions where the microspheres are not bound together by the matrix material. Optionally, this Step 32 can be avoided and the microspheres evacuated only once they are placed in the mold.

Step 33: A mold is prepared by evacuation of gases from the mold, such evacuation being sufficient to allow for the infusion of a fluid matrix material in subsequent processing Step 36, with a minimum of entrapment of gas bubbles, in order to avoid the formation of flawed regions where the microspheres are not bound together by the matrix material.

Step 34: The evacuated mold is filled with the evacuated microspheres while vibrating the mold in order to encourage maximum compaction of the microspheres and to maximize the filling of all voids within the mold.

Step 35: A fluid matrix material is degassed, with the degassing being sufficient to minimize the formation of gas bubbles in subsequent processing Step 36, in order to avoid the formation of flawed regions where the microspheres are not bound together by the matrix material.

Step 36: The degassed fluid matrix material is infused into the mold, filling the remaining void space around the microspheres within the mold void space.

Step 37: Optionally, excess fluid matrix material can be removed by centrifuging the mold, leaving a surface coating of the liquid phase material covering the exposed surface areas of the solid phase. The average thickness of the remaining surface coating can be controlled by the duration and speed of the centrifuging process.

Removing excess fluid matrix material can be desirable in order to reduce the density of the finished MSF material. Removing excess fluid matrix material can result in the formation of a network of interconnected void spaces, which can allow for the exhausting of any gases generated by the solidification process, or it can allow for gas exchange such as the absorption of water vapor during the curing of some epoxy or silicone type of fluid matrix phases. This can speed up the process of solidification and/or it can improve the strength of the finished MSF material by allowing for gases generated by the solidification process to exit the liquid phase normal to the surface layer, rather than allowing gas bubbles to form, causing flaws that may reduce the strength of the finished MSF material.

### Production Apparatus for Direct Molding of MSF Materials:

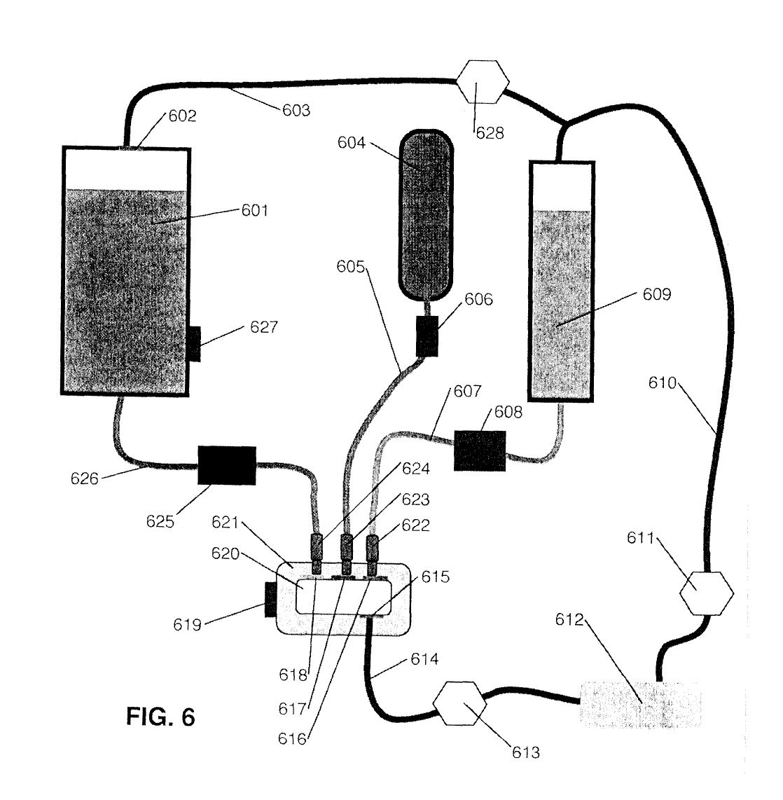

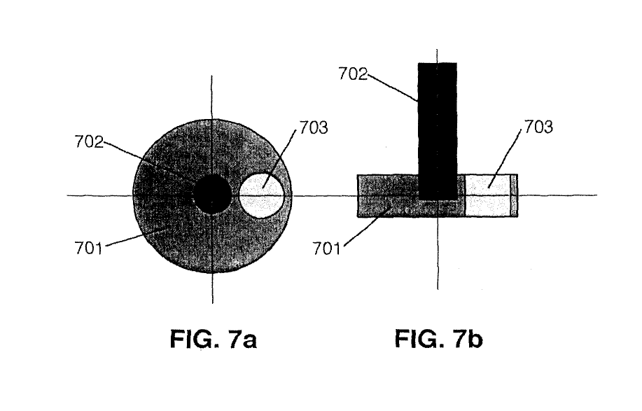

With reference to FIG. 6 and FIG. 7, an embodiment of an apparatus according to the present invention is disclosed for the production of MSF materials by delivery of the component materials directly to a mold in accordance with one embodiment of a method according to the present invention.

A mold 621 with mold void 620 is provided with component materials for forming a composite MSF material as follows:

a) solid phase material is delivered to mold 621 from a storage vessel 601, which communicates with the mold void 620 via ducting 626, through metering auger 625 and through quick connect attachment 624.

b) fluid phase matrix material is delivered to mold 621 from a storage vessel 609, which communicates with the mold void 620 via ducting 607, through metering pump 625 and through quick connect attachment 622.

c) gas phase material is delivered to mold 621 from a pressurized storage vessel 604, which communicates with the mold void 620 via ducting 605, through metering regulator valve 606 and through quick connect attachment 623.

Excess matrix fluid is optionally removed from mold volume 620 by means of a vacuum created by vacuum pump 612, which communicates with mold volume 620 via ducting 614, passing through trap 613, which recovers excess fluid.

Vacuum pump 612 communicates with mold volume 621, storage vessel 601 and storage vessel 609 for the purposes of drawing a vacuum and degassing materials in accordance with a method according to the present invention. Vacuum traps 613, 611 and 628 recover materials drawn into the ducting and protect the vacuum pump from potentially damaging solid or liquid materials.

Vibrator motors 627 and 619 vibrate the parts of the apparatus through which solid phase materials flow in order to promote flow and to promote close packing of the solid phase particles within the mold void 620.

Rotary hole gate 618 allows solid phase particles to enter the mold void 620 during filling of the mold void 620 with solid phase particles. Once the mold void 620 is filled with solid phase particles, the rotary hole gate 618 is rotated so that the gate 618 closes off the entry hole, and keeps the solid phase particles constrained within the mold void 620, such that the solid phase particles are constrained so that movement out of close contact with each other and the mold containment surfaces is prevented or at least minimized, preventing any significant amount matrix fluid from inserting between the contact points during subsequent process steps. Such insertion of a significant amount of matrix fluid would be undesirable since it would lead to shrinkage and distortion of the molded part as the matrix fluid is hardened in subsequent steps as described in the method of FIG. 3. Rotary hole gate 618 is shown in more detail in FIG. 7 and described below.

Rotary filter gate 616 allows matrix fluid to enter the mold void 620 when in the open or at least partially open position and prevents solid phase particles from exiting the mold void 620. In the closed position, the filter gate 616 closes off the mold void 620 while mechanically constraining the solid phase particles to remain in close contact with each other within the mold void 620 during subsequent steps. Rotary filter gate 618 is shown in more detail in FIG. 7 and described below.

Rotary filter gate 615 allows gases and excess matrix phase liquids to exit the mold void 620 when in the open position and prevents solid phase particles from exiting the mold void 620. In the closed position, the filter gate 615 closes off the mold void 620 while mechanically constraining the solid phase particles to remain in close contact with each other within the mold void 620 during subsequent steps.

Rotary filter gate 617 allows gases from pressure vessel 604 to enter the mold void 620 when in the open position and prevents solid phase particles from exiting the mold void 620. In the closed position, the filter gate 617 closes off the mold void 620 while mechanically constraining the solid phase particles to remain in close contact within the mold void 620 during subsequent steps.

Filter 602 allows gas to evacuate from vessel 601 while preventing the passage of particulates of the size range used as the solid particle phases of the composite MSF material being formed.

The described apparatus can be automated for rapid sequential filling of a series of mold forms for volume production of MSF material parts.

### Rotary Hole Gate and Rotary Filter Gate:

The basic common structure of a rotary hole gate which also serves as the basic structure of a rotary filter gate according to one or more embodiments of the present invention is shown in more detail in FIGS. 7a and 7b.

A solid disk 701 is mounted on a shaft 702 and constrained within a closure (not shown) such that the through passage 703 allows communication with the mold void 620 in the open position and when rotated to a closed position by an actuator (not shown) closes off communication with the mold void 620.

In the case of a rotary hole gate, the through passage 703 is an open hole that allows the passage of gases, liquid and particulates of the size range used as the solid particle phases of the composite MSF material being formed.

In the case of a rotary filter gate, the through passage 703 is filled with a suitable filtering material (not shown) that allows the passage of fluids and gases, but does not allow the passage of particulates of the size range used as the solid particle phases of the composite MSF material being formed.

### Production Apparatus for Molding of Liquid Form MSF Materials:

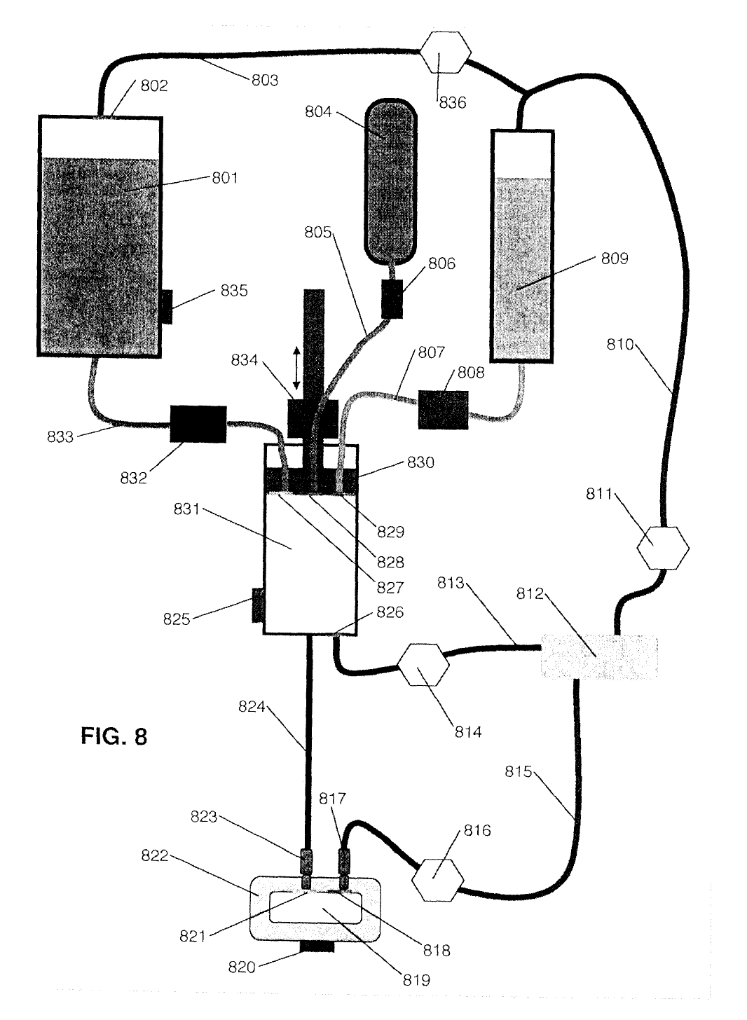

With reference to FIG. 8, a preferred form of apparatus is disclosed for the production of MSF materials by delivery of the component materials to an infusion chamber 831 from which liquid form MSF Materials can be delivered to a mold in accordance with one embodiment of the Method described in FIG. 3.

An infusion chamber 831 is supplied with component materials for forming a composite liquid form MSF material as follows:

a) Solid phase material is delivered to infusion chamber 831 from a storage vessel 801, which communicates with the infusion chamber 831 via ducting 833, through metering auger 832 and through the platen of metering ram 830.

b) Fluid phase matrix material is delivered to infusion chamber 831 from a storage vessel 809, which communicates with the infusion chamber 831 via ducting 807, through metering pump 808 and through the platen of metering ram 830.

c) Gas phase material is delivered to infusion chamber 831 from a pressurized storage vessel 804, which communicates with the infusion chamber 831 via ducting 805, through metering regulator valve 806 and through the platen of metering ram 830.

Excess matrix fluid is optionally removed from infusion chamber 831 by means of a vacuum created by vacuum pump 612, which communicates with infusion chamber 831 via ducting 813, passing through trap 814, which recovers excess fluid.

Vacuum pump 812 communicates via ducting with mold volume 819, infusion chamber 831 storage vessel 801 and storage vessel 809 for the purposes of drawing a vacuum and degasing materials in accordance with the method described in FIG. 3. Vacuum traps 816, 814, 811 and 836 recover any materials drawn into the ducting and protect the vacuum pump from potentially damaging solid or liquid materials.

Vibrator motors 835, 825 and 820 vibrate the parts of the apparatus through which solid phase materials flow in order to enhance flow and to enhance close packing of the solid phase particles within infusion chamber 831 and the mold void 820.

Rotary hole gate 827 allows solid phase particles from vessel 801 to enter infusion chamber 831 during filling of the chamber with solid phase particles. Once the chamber is filled with solid phase particles, the rotary hole gate is rotated so that the gate 827 closes off the entry hole, and keeps the solid phase particles constrained within infusion chamber 831, such that the solid phase particles cannot move out of intimate contact with each other and the mold containment surfaces, preventing any significant amount matrix fluid from inserting between the contact points during subsequent process steps. Such insertion of matrix fluid would be undesirable since it would lead to shrinkage and distortion of the molded part as the matrix fluid is hardened in subsequent steps as described in the method of FIG. 3.

Rotary filter gate 829 allows matrix fluid from vessel 809 to enter infusion chamber 831 when in the open position; prevents solid phase particles from exiting infusion chamber 831; and closes off infusion chamber 831 while mechanically constraining the solid phase particles to remain in close contact within infusion chamber 831 during subsequent steps.

### Fluid Form MSF Material:

Fluid Form MSF Material can be taken from the process after Step 36 or after optional Step 37. Fluid form MSF Materials can be used for purposes such as a bonding material for bonding applications, as a filler material for repair applications, or as a material for use in subsequent molding operations, amongst others.

Without being bound by theory, it is hypothesized that at the micrometer and nanometer scale, gravitational force is a second order force acting on the fluid matrix phase compared to surface tension forces and surface adhesion forces. Surface tension forces of the fluid matrix phase together with surface adhesion forces between the fluid matrix phase and the solid phase surfaces will determine the shape and location of the void spaces between solid surfaces. Therefore in general, the void shapes will be centered between surrounding solid surfaces, as illustrated by the location of the void spaces 25 in FIG. 2.

Without being bound by theory, it is hypothesized that when a Fluid Form MSF Material is made in accordance with the method of manufacture described in FIG. 3, the surface tension forces of the fluid matrix phase together with surface adhesion forces between the fluid matrix phase and the solid phase surfaces will act to minimize the surface area of the liquid phase material, thereby acting to hold together the solid particles in touching contact and to prevent the separation of the contact points between the solid phase particles. This means that a Fluid Form MSF Material will remain a MSF material with the solid phase particles in touching contact even without a containing mold.

In one or more embodiments of the present invention, removing excess fluid matrix material as described in Step 37 is preferred for the formation of a Fluid Form MSF Material. If excess fluid matrix material is present, the solid phase particles will be free to move apart without constraint from surface tension forces. If it is then placed in a mold and solidified, such a material would as a result suffer some degree of shrinkage and twisting, since the essential condition of a rigid solid particle spaceframe would no longer be present.

A Fluid Form MSF Material can be prepared in a bulk batch and can then be flowed or injected under pressure into molds; it can be flowed or injected to fill the space between solid shapes and then partially or fully solidified to bond the solid shapes together. In particular, a Fluid Form MSF Material can be used as a bonding material for forming precision bonds between components, as described below under the heading “Precision Bonding and Assembly Using MSF Materials”.

Once they have been shaped (for example by molding or pressing) as required for any given application, Fluid Form MSF Materials are generally then further processed in accordance with Step 38 of FIG. 3 to produce Green Form MSF Material and/or Step 39 of FIG. to produce a Plastic Form MSF Material or a Hard Form MSF Material.

Step 38: Optionally, the fluid matrix material is then partially solidified by a process appropriate to the matrix material, such as cooling, curing, thermal decomposition or chemical reaction. Controlling the portion of the fluid matrix material that is solidified can vary the degree of hardness. The optimum degree of hardness for a Green Form MSF Material for any given application will be determined by the minimum safe hardness required for the Green Form MSF Material to withstand handling and processing, without significant damage, wear or loss of precision.

Green Form MSF Material: Green Form MSF Material is produced at the completion of Step 38 of FIG. . The result is a soft yet rigid Green Form MSF Material, similar in softness and rigidity to “green” pottery, which is created by partially firing clay materials. These materials are “soft” in the sense that they are easily cut or abraded with relatively low force and have low mechanical strength compared to a fully hardened material.

Step 39: The fluid matrix material is solidified by a process appropriate to the matrix material, such as cooling, curing, thermal decomposition or chemical reaction.

Hard Form MSF Material: Hard Form MSF Material is produced at the completion of Step 39 of FIG. .

Plastic Form MSF Material: Plastic Form MSF Material is produced at the completion of Step 39 of FIG. 3.

Plastic Form MSF material can be extruded or drawn through a die to produce extruded or drawn shapes; it can be pressed or stamped in a die or form; and it can be otherwise formed and fashioned by injection molding, stamping, rolling or other forming processes known to those familiar with the art. Generally, a MSF material will have plastic properties if the matrix material has plastic properties. Plastic Form MSF material may require heating, for example if the matrix material is a thermoplastic, to exhibit plastic properties.

A discovery of this invention is that, if the particle phase is comprised of microspheres, Plastic Form MSF materials will exhibit better properties for being flowed, injected or drawn than does either: the native plastic matrix material on its own; the native plastic matrix material mixed with a lower volume percentage of the same microspheres (for example conventional syntactic foams), or the native matrix material mixed with other particles or fibers. Such improved properties include: lower viscosity; lower pressures and/or temperatures required for processing; greater precision in forming finely detailed or complex shapes or surface patterns; reduced wear to molds, tooling and processing equipment; and greater ease of manufacturing and lower capital and operating costs of manufacturing resulting from these improved properties. The microspheres act as tiny ball bearings which rotating and easily moving past each other in a fluid fashion. This reduces viscosity and acts as a lubricant for cutting or abrasion tools as the tiny microspheres roll under the blade or tool contact surface.

A key discovery of this invention is that when a material is made in accordance with the method of manufacture described with reference to FIG. 3, a MSF material is formed that has advantages over the existing art with respect to one or more of the following desirable properties: low formation distortion, low bulk density; low bulk thermal expansion; low bulk thermal distortion; low thermal conductivity; high thermal and chemical stability; high impact energy absorption; low sound transmission; high mechanical strength; low defect formation; low defect propagation; low cost of production; improved ease of machinability; improved precision net shape casting; improved precision assembly and bonding of component parts; improved establishment and maintenance of precision tolerances and stack-up precision tolerances in three spatial dimensions in simple or complex assemblies of component parts; reduced part counts for component assemblies; and improved ease of manual or automated assembly of components.

### Microspheres:

The term “microspheres”, as used in this description, refers to micrometer-scale hollow particles of approximately spherical shape. Microspheres are also commonly referred to as microballoons or microbubbles. It is to be understood that the solid particle phase of a MSF material can consist of particles with dimensions less than, or greater than, micrometer-scale. Examples of hollow solid phase particles suitable for use in the present invention include, but are not limited to: hollow or cellular glass microspheres; hollow polymeric microspheres; hollow ceramic microspheres; cenospheres; and natural perlites.

Among other advantages, a discovery of the present invention is that by incorporating low-density solid phase particles, such as hollow glass microspheres, hollow polymeric microspheres, hollow ceramic microspheres, or natural perlite materials, the density of MSF materials can be reduced to about 0.4 to 0.7 grams per cubic centimeter compared to conventional solid ceramic materials with densities of about 2 to 3 grams per cubic centimeter, or compared to solid metal like aluminum (2.7 grams per cubic centimeter) or stainless steel (about 8 grams per cc), while still maintaining good to excellent material strength because of reduced flaw formation, as discussed above.

Suitable microspheres can include those commercially available, such as those manufactured by 3M, Expancel, Pierce & Stevens Corp., or Emerson & Cuming, Inc. Perlites are natural multi-cellular hollow micro-spheres. Perlites are hydrated rhyolitic volcanic glass containing between two and five percent of chemically combined water, which permits production of an expanded cellular material of extremely low bulk density when the ore is heated to its softening temperature. Cenospheres are hollow microspheres typically produced as a byproduct of coal combustion at thermal power plants, with a density of about 0.4-0.8 g/cc. They have a melting temperature of about 1300 degrees Celsius, making them suitable for use in high-temperature applications. Cenospheres are generally lower in cost than manufactured microspheres and are available from numerous sources, such as Ceno Technologies Inc.

The true density of these lightweight microsphere filler materials can be in a range from 0.05 to 0.70 g/cc. In one preferred embodiment, the hollow microspheres are hollow glass microspheres with a density of 0.1 to 0.35 g/cc.

The materials used for the hollow microsphere materials can be made of organic or inorganic materials such as glass, ceramic, perlite, and polymeric materials, although the invention is not limited to these materials. The shapes of these materials, in general, are generally geometrically spherical and single celled, encapsulated with air or other lightweight gaseous materials. Multi-celled microspheres with irregular shapes are also commercially available (e.g., perlite).

As an example of the foregoing, a preferred hollow glass microsphere is the K1 microsphere, which is manufactured by 3M, St. Paul, Minn. The true density of K1 is about 0.125 g/cc, and the materials are made of soda-lime-borosilicate type of inorganic materials. S22 is another hollow glass micro-sphere offered by that supplier. The difference between K1 and S22 is that K1 has a true density of 0.125 g/cc and S22 has a true density of 0.22 g/cc. The diameter of K1 microspheres is much larger than that of S22. S22 may have better crush strength than K1 spheres.

### Surface Treatment:

The surfaces of the particle phase can be optionally coated to enhance the strength of surface bonding between the particle phase and the matrix phase. For example, an epoxy silane coupling agent can be used to enhance bonding of an organic matrix material, such as an organic resin or epoxy, to an inorganic particle phase, such as glass or ceramic microspheres.

### Precision Bonding and Assembly Using MSF Materials:

Fluid Form MSF materials can generally be used as MSF bonding materials to bond together solid parts made of the same MSF solid phase and matrix phase material composition, or from differing compositions.

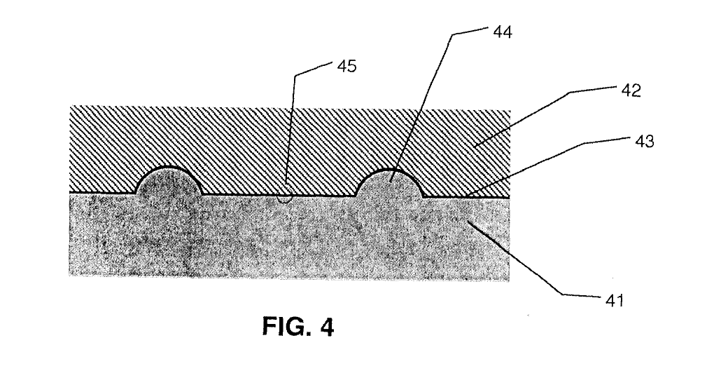

Referring to FIG. 4, a cross sectional view is shown of a part 41 bonded to a mating surface of a second part 42 by a bonding layer of MSF Bonding Material 43 manufactured according to one embodiment of this invention. FIG. 4 not drawn to scale.

Part 41 is shown as having joining elements 44 consisting of convex surface protrusions, which mate with complementary concave intrusions of part 32 for the purpose of mechanically strengthening the joint between part 41 and part 42, and for the purpose of aiding the precision location of part 42 with respect to part 42 during assembly. MSF Bonding Materials can also bond parts without the use of joining elements. In general, someone skilled in the art can determine the number, shape and location of such joining elements 44.

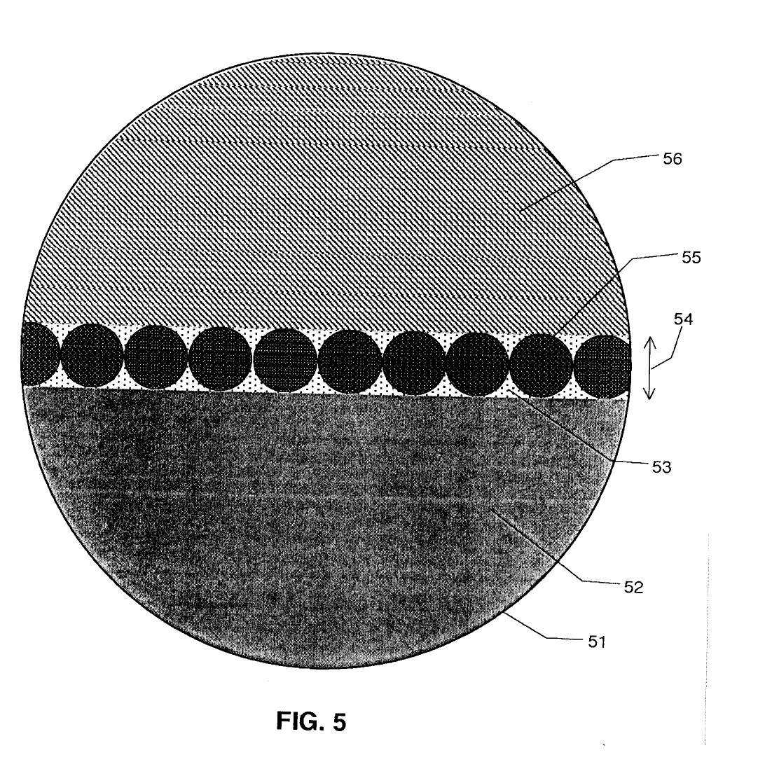

The composite elements forming the MSF material are generally of micrometer or nanometer size, and therefore at a scale visible to the human eye, the MSF Bonding Material 43 appears to be a uniform solid. A small circular area 35 of the MSF Bonding Material 43 is shown magnified in FIG. 5 in order to show the structure of the MSF Bonding Material.

A solid particle phase of a MSF bonding material 43 is shown in FIG. 5, consisting of many microspheres 55 of equal diameter, referred to as “monodisperse”. The microspheres shown here are solid and are solid and monodisperse, but in general the microspheres for a MSF bonding material can be hollow or solid, and can be monodisperse or disperse in size.

Each microsphere 55 is typically in mechanical contact with six nearest neighbor microspheres and with the mating surfaces of part 52 and part 56, providing compressive strength and distribution of compressive forces.

The matrix phase 53 surrounds the microspheres 55 and preferably is present in sufficient quantity to make contact with all of or nearly all of the area of the mating surfaces.

The matrix phase 53 of a MSF bonding material can be any fluid that will solidify and bond to both the particle phase and to both of the mating surfaces with sufficient strength, and that has other physical properties, such as thermal expansively, that are compatible with the materials of the parts being bonded.

The bonding layer MSF bonding material 54 is compressed to diameter of a single microsphere 55, provided that the mating surfaces are smooth and precisely complementary relative to diameter of the microspheres of the solid phase.

A discovery of the present invention is that, used in accordance with the teachings of this invention, MSF bonding materials have the following advantages over conventional bonding materials for precision bonding:

a) Low-Shrinkage, Low-Distortion: Conventional bonding materials tend to shrink and twist as they solidify or harden reducing the strength of bonds and reducing the precision with which component parts can be assembled. MSF bonding materials exhibit negligible shrinkage and negligible distortion during bonding, keeping the relative position and relative orientation of a MSF bonded assembly of parts precise to a degree not possible—or costly to achieve—with conventional bonding materials.

b) Precision Thickness: With conventional bonding materials, the thickness of the bonding layer is difficult to keep at precisely the optimum thickness over the entire surface area of the mating surfaces as parts are pressed together, which results in weaker bond formation, and loss of precision with respect to relative position and relative orientation of the parts. A bonding layer of MSF bonding materials using monodisperse microspheres always compresses to a bonding layer thickness of precisely the diameter of the microspheres.

For precision bonding of two parts at mating surfaces, MSF bonding material is metered onto the lower mating surface, generally as a droplet at the geometric center of the lower surface, or as a line of MSF bonding material laid as a line along the major geometric centerline of the lower surface. The mating surfaces of the two parts are pressed together, preferably by a precision, six-axis actuator with the associated precision metrology to achieve micrometer or nanometer positioning and precise application force during bonding.

If the parts to be bonded are both comprised of the same MSF material, then generally the preferred MSF bonding material will be that same MSF material in fluid form, in order to ensure optimum compatibility with respect to physical properties, such as thermal expansively.

### Syntactic Foam:

Syntactic foams are composite materials synthesized by filling a metal, polymer or ceramic matrix with hollow particles called microballoons, with microspheres being one type of microballoon. The presence of hollow particles results in lower density, higher strength, a lower coefficient of thermal expansion, and, in some cases, radar or sonar transparency.

The conventional method of producing syntactic foam is to mechanically mix the microballoons into the matrix material. This conventional method has three essential disadvantages: breakage of microballoons during mixing, poor mixing at higher volume fractions of microspheres, and flaw formation.

A discovery of the current invention is that syntactic foam materials made in accordance with the teachings of this invention and the method described in FIG. 3 have the following advantages over conventional bonding materials for precision bonding:

Less Breakage: The shear forces involved in mechanical mixing results in the breaking or disintegration of many microballoons, particularly with more viscous matrix materials, which includes most epoxy, metal, organic polymer and ceramic matrix materials. This breakage generally reduces all of the advantageous properties of syntactic foams. The percentage of broken microballoons generally increases with higher volume fractions of microballoons. Processes to remove the broken microspheres are expensive. Mixing is generally carried out at low speeds to minimize breakage, however this increases processing time and costs.

Syntactic foam material prepared in accordance with the method described in FIG. 3 has significantly fewer broken microspheres, since no mechanical mixing is used.

Better Bonding: With a viscous matrix material, as the volume fraction of microballoons increases, fewer of the microspheres are fully coated by the matrix material during mixing. This means that the bonding of the matrix phase to the particle phase becomes weaker, reducing the strength and the elastic modulus properties of the syntactic foam. Many desirable properties of syntactic foams, such as lower density and greater compressive strength improve with the volume fraction of microballoons, however poor mixing properties often limits the volume fraction of microballoons to less than the theoretical packing volume maximum.

The use of the method described in FIG. 3 produces syntactic foams that have much more complete coating of microballoons, since the fluid matrix is infiltrated into an evacuated particle phase. With the use of Method 20, the volume fraction microballoons approaches the theoretical packing volume maximum, since the mold volume is completely filled with microballoons while the mold is being vibrated.

Fewer Flaws: Mechanical mixing of microballoons into a matrix material generally entraps gases within the mix. These entrapped bubbles are flaws at which stresses can concentrate, significantly reducing the compressive strength and elastic moduli of the syntactic foam. Mechanical mixing also generally produces non-uniform mixtures with regions of lower or higher concentrations of microballoons within the matrix material. These non-uniform regions are flaws at which stresses can concentrate, significantly reducing the compressive strength and elastic moduli of the syntactic foam.

The use of the method described in FIG. 3 produces syntactic foams that have fewer flaws from entrapped gases, since the fluid matrix is infiltrated into an evacuated particle phase.

The use of the method described in FIG. 3 produces syntactic foams that have fewer flaws from non-uniform concentrations of microballoons within the matrix material.

In certain embodiments of compositions and methods of the present invention, particulates (also referred to in certain embodiments as filler or solid phase material) are in mechanical contact; in certain other embodiments, the contact is close contact; in certain other embodiments the contact is substantially close contact; in certain other embodiments, the contact comprises a majority of individual particles of the solid particulate material are in contact with at least one adjacent solid particulate particle; in certain other embodiments, the contact is substantial contact; in certain other embodiments the contact is substantial mechanical contact; in certain other embodiments, the contact comprises substantially all of the solid particulates in contact with at least two adjacent solid particulate particles; in certain other embodiments, the contact is sufficiently close to minimize shrinkage of a composition according to the present invention.

While the invention has been described in terms of its preferred embodiments, those skilled in the art will recognize that the invention can be practiced with modification within the spirit and scope of the described invention.

1. A composition comprising:
microspheres packed closely in contact; and
a matrix material encapsulating the microspheres to reinforce the contact between the microspheres.

2-12. (canceled)

13. The composition of claim 1 wherein the matrix material is selected from the group consisting of a polymer, a metal, and a metal alloy.

14. (canceled)

15. A method comprising:
providing a particulate material,
providing a mold,
evacuating gas from void spaces between the particulate material,
evacuating gas from the mold,
introducing the evacuated solid particulate material into the mold, and
introducing a fluid matrix material into the void spaces while constraining the particulate material in the mold.

16-28. (canceled)

29. The method of claim 15 further comprising:
compacting the particulate material prior to introducing the fluid matrix material into the mold.

30. The method of claim 29 wherein the compacting comprises vibration.

31. (canceled)

32. The method of claim 15 further comprising the step of degassing the fluid matrix material prior to introducing the fluid matrix material into the mold.

33. The method of claim 15 further comprising coating the particulate material with a surface coating to enhance bonding between the particulate material and the fluid matrix material.

34. (canceled)

35. The method of claim 15 wherein the particulate filler material comprises microspheres.

36. (canceled)

37. The method of claim 15 further comprising removing excess fluid matrix material from the mold.

38-42. (canceled)

43. The composition of claim 1 wherein the matrix material comprises a ceramic material.

44. The composition of claim 43 wherein the ceramic material is formed from a liquid precursor,

45. The composition of claim 1 wherein the microspheres have a microscale diameter.

46. The composition of claim 1 wherein the microspheres have a nanoscale diameter.

47. The composition of claim 1 wherein the microspheres are hollow.

48. The composition of claim 47 wherein the microspheres are selected from any one of cellular glass microspheres; hollow polymeric microspheres; hollow ceramic microspheres; cenospheres; and natural perlites.

49. The composition of claim 47 wherein the microspheres comprise ceramic or glass.

50. The composition of claim 1 wherein the rnicrospheres are packed closely approaching a theoretical packing volume maximum of the microspheres.

51. The method of claim 37 wherein the fluid matrix material is removed by centrifuging the mold.

52. The method of claim 15 wherein the fluid matrix is a ceramic material.

53. The method of claim 15 wherein the fluid matrix is selected from the group consisting of a polymer; a metal; or a metal alloy.

54. The method of claim 35 wherein the microspheres have a microscale diameter.

55. The method of claim 35 wherein the microspheres have a nanoscale diameter.

56. The method of claim 35 wherein the microspheres are hollow.

57. The method of claim 35 wherein the microspheres are selected from any one of cellular glass microspheres; hollow polymeric microspheres; hollow ceramic microspheres; cenospheres; and natural perlites.

58. The method of claim 35 wherein the microspheres comprise ceramic or glass.

59. The composition of claim 13, wherein the polymer comprises at least one of a thermoplastic, a resin, or an epoxy, the metal comprises aluminum or magnesium, or a combination thereof.

60. The method of claim 53, wherein the polymer is selected to comprise at least one of a thermoplastic, a resin, or an epoxy, the metal comprises aluminum or magnesium, or a combination thereof.
